(19) United States
(12) Patent Application Publication
(10) Pub. No.: US 2009/0128874 A1
(43) Pub. Date: May 21, 2009

(54) HOLOGRAM RECORDING DEVICE

(75) Inventors: Yasumasa Iwamura, Kawasaki (JP); Kazushi Uno, Kawasaki (JP); Koichi Tezuka, Kawasaki (JP); Hiroyasu Yoshikawa, Kawasaki (JP); Yuzuru Yamakage, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/356,795

(22) Filed: Jan. 21, 2009

Related U.S. Application Data
(63) Continuation of application No. PCT/JP2006/314959, filed on Jul. 28, 2006.

(51) Int. Cl. G03H 1/26

(52) U.S. Cl. 359/22

(57) ABSTRACT

A hologram recording device (A1) includes a laser (1), a beam splitter (3) splitting the laser beam from the laser (1) into recording and reference beams (S), (R), a spatial light modulator (5) modulating the recording beam (S) by record information, a recording opto-system directing the modulated beam (S) to a target site of a hologram recording medium (B), and a reference opto-system directing the reference beam (R) to the target site of the recording medium (B) for interference with the recording beam (S) through difference incident angles. The beam (S)-beam (R) interference enables multiplex hologram recording at the target site. The device (A1) further includes a light amount adjustor (8) that adjusts the amount of the reference beam (R) from the splitter (3) based on the incident angle to the recording medium (B) for keeping the illuminance of the reference beam (R) at the target site at a predetermined level.

This application is a Continuation of International Application No. PCT/JP2006/314959, filed Jul. 28, 2006.

### TECHNICAL FIELD

The present invention relates to a hologram recording device for performing multiplex hologram recording on a hologram recording medium by causing a reference beam and a recording beam to interfere with each other by an angle-multiplexed recording method.

### BACKGROUND ART

A conventional hologram recording device is disclosed in Patent Document 1. In the hologram recording device disclosed in this document, laser beam emitted from a light source is split into a recording beam and a reference beam by a polarization beam splitter. The recording beam is modulated by a spatial light modulator and then caused to impinge on a predetermined portion of a hologram recording medium. The reference beam is caused to impinge on the hologram recording medium while changing the incident angle with respect to the hologram recording medium so that the reference beam interferes with the recording beam at the predetermined portion at various angles.

A ½ wave plate for changing the polarization state of the laser beam before entering the polarization beam splitter is provided between the light source and the polarization beam splitter. When the incident angle of the reference beam is to be changed, the ½ wave plate is appropriately rotated to change the ratio of the amount of the laser beam to the amount of the reference beam after being split by the polarization beam splitter. With this arrangement, even when the irradiation area of the reference beam at the predetermined portion changes due to the change of the incident angle of the reference beam, the ratio of the illuminance of the recording beam to the illuminance of the reference beam is kept constant (preferably kept 1:1). This ensures multiplex recording of holograms having a good light/dark contrast.

Patent Document 1: JP-A-2005-173361

However, in the above-described conventional hologram recording device, to keep the ratio of the illuminance of the recording beam to that of the reference beam constant is only considered. Specifically, as the incident angle of the reference beam increases, the irradiation area of the reference beam increases, so that the ½ wave plate is rotated to increase the amount of the reference beam. However, the amount of the recording beam reduces as the amount of the reference beam increases. As a result, although the illuminance ratio is kept constant, the illuminance itself provided by the combination of the recording beam and the reference beam at the predetermined portion reduces as the incident angle of the reference beam increases. Thus, the power used for recording holograms varies in accordance with the incident angle of the reference beam, which hinders multiplex recording of holograms with a constant illuminance.

### DISCLOSURE OF THE INVENTION

The present invention has been proposed under the circumstances described above. It is, therefore, an object of the present invention to provide a hologram recording device which is capable of performing multiplex hologram recording with a constant illuminance.

To solve the problem described above, the present invention takes the following technical measures.

According to a first aspect of the present invention, there is provided a hologram recording device comprising: a light source for emitting a laser beam; a beam splitter for splitting the laser beam from the light source into a recording beam and a reference beam; a spatial light modulator for modulating the recording beam in accordance with the information to be recorded; a recording optical system for causing the modulated recording beam to impinge on a predetermined portion of a hologram recording medium; and a reference optical system for causing the reference beam to impinge on the hologram recording medium while changing the incident angle of the reference beam with respect to the recording medium, so that the reference beam interferes with the recording beam at the predetermined portion at various angles. As a result, multiplex hologram recording is performed at the predetermined portion by the interference between the recording beam and the reference beam. The hologram recording device further comprises a light amount adjustor for variably adjusting the amount of the reference beam from the beam splitter in accordance with the incident angle with respect to the hologram recording medium, so that the illuminance of the reference beam at the predetermined portion is kept at a predetermined level.

Preferably, the beam splitter may be a polarization beam splitter, and a phase plate for applying a predetermined phase shift to the recording beam may be provided between the polarization beam splitter and the spatial light modulator.

According to a second aspect of the present invention, there is provided a hologram recording device comprising: a light source for emitting a laser beam; a polarization beam splitter for splitting the laser beam from the light source into a recording beam and a reference beam; a spatial light modulator for modulating the recording beam in accordance with the information to be recorded; a phase plate for applying a predetermined phase shift to the recording beam between the polarization beam splitter and the spatial light modulator; a recording optical system for causing the modulated recording beam to impinge on a predetermined portion of a hologram recording medium; and a reference optical system for causing the reference beam to impinge on the hologram recording medium while changing the incident angle of the reference beam with respect to the recording medium, so that the reference beam interferes with the recording beam at the predetermined portion at various angles. As a result, multiplex hologram recording is performed on the predetermined portion by the interference between the recording beam and the reference beam. The hologram recording device further comprises a light adjustor for variably adjusting the amount and phase of the laser beam before entering the polarization beam splitter in accordance with the incident angle with respect to the hologram recording medium, so that the illuminance of each of the recording beam and the reference beam at the predetermined portion is kept at a predetermined level.

Preferably, the light adjustor may comprise an output controller for controlling the laser beam output from the light source and a phase adjustor for applying various phase shifts to the laser beam.

Preferably, the light adjustor may comprise a light amount adjustor for variably adjusting the amount of the laser beam and a phase adjustor for applying various phase shifts to the laser beam.

### BRIEF DESCRIPTION OF THE DRAWINGS

FIG. 1 is an overall structural view showing a hologram recording device according to a first embodiment of the present invention.

FIG. 2 shows the optical operation of the hologram recording device shown in FIG. 1.

FIG. 3 is an overall structural view showing a hologram recording device according to a second embodiment of the present invention.

FIG. 4 shows the optical operation of the hologram recording device shown in FIG. 3.

FIG. 5 is an overall structural view showing a hologram recording device according to a third embodiment of the present invention.

FIG. 6 shows the optical operation of the hologram recording device shown in FIG. 5.

### BEST MODE FOR CARRYING OUT THE INVENTION

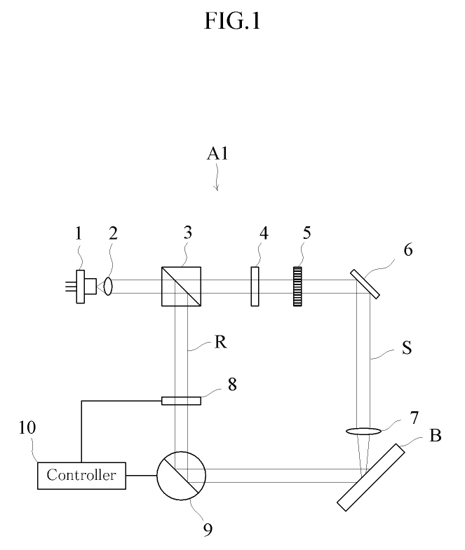

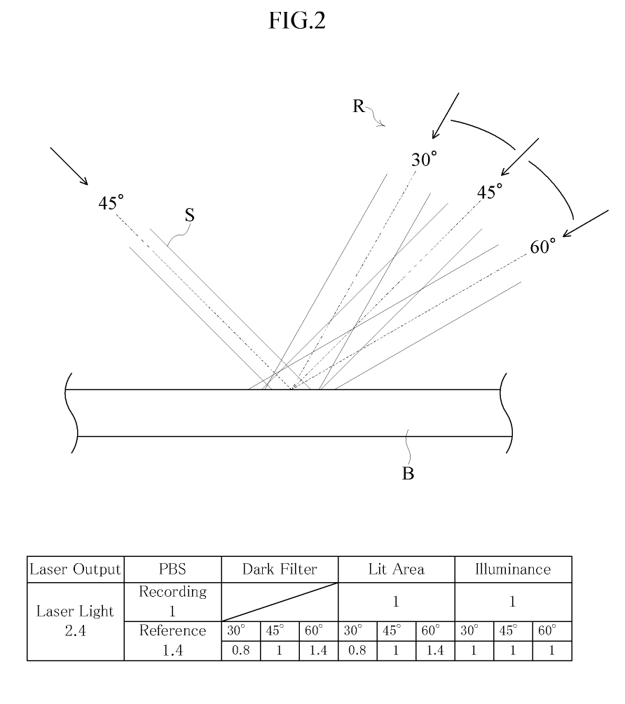

Preferred embodiments of the present invention will be described below with reference to the accompanying drawings. FIGS. 1 and 2 show a hologram recording device according to a first embodiment of the present invention.

As shown in FIG. 1, the hologram recording device A1 is designed to perform multiplex hologram recording on a hologram recording medium B by an angle-multiplexed recording method. The hologram recording device A1 includes a light source 1, a collimating lens 2, a polarization beam splitter (hereinafter referred to as “PBS”) 3, a ½ wave plate 4, a spatial light modulator 5, a stationary mirror 6, an objective lens 7, a dark filter (light amount adjustor) 8, a movable mirror 9 for reference beam, and a controller 10. The stationary mirror 6 and the objective lens 7 constitute a recording optical system for guiding a recording beam S to the hologram recording medium B. The movable mirror 9 constitutes a reference optical system for guiding a reference beam R to the hologram recording medium B while changing the incident angle.

The recording beam S and the reference beam R are caused to impinge on a predetermined portion of the hologram recording medium to overlap each other, whereby a hologram made of an interference pattern is recorded on the portion. Specifically, in this process, by changing the angle of incidence of the reference beam B with respect to the hologram recording medium B, holograms made up of different interference patterns in accordance with the angle at which the recording beam S and the reference beam R intersect with each other are recorded on the predetermined portion in a multiplexed manner.

The light source 1 comprises e.g. a semiconductor laser device and emits a laser beam having a relatively narrow band and a highly coherency. The collimating lens 2 converts the laser beam emitted from the light source 1 into a parallel beam. The parallel beam emitted from the collimating lens 2 is split by the PBS 3 into a recording beam S and a reference beam R of different polarization directions. The recording beam S, which is e.g. an s-polarized light provided by the splitting by the PBS 3, is converted into a p-polarized light by subsequently passing through the ½ wave plate 4. The recording beam S converted into a p-polarized light enters the spatial light modulator 5. In the spatial light modulator 5, the recording beam is modulated into a light of a pixel pattern corresponding to the information to be recorded. The recording beam S exiting the spatial light modulator 5 is directed to a predetermined portion of the hologram recording medium B via the stationary mirror 6 and the objective lens 7. The incident angle of the recording beam S with respect to the hologram recording medium B is set to about 45°, for example.

The reference beam R, which is e.g. a p-polarized light provided by the splitting by the PBS 3, enters the dark filter 8. The dark filter 8 comprises an ND filter or a liquid crystal device combined with a polarizer and is rotatable under the control by the controller 10. The amount of reference beam R reduced by the dark filter 8 varies depending on the rotational posture of the filter. The reference beam R exiting the dark filter 8 is directed to the predetermined portion of the hologram recording medium B via the movable mirror 9 so as to overlap the recording beam S. The movable mirror 9 is rotatable under the control by the controller 10. By the operation of the movable mirror 9, the incident angle of the reference beam R with respect to the predetermined portion is changed within a range of e.g. 30 to 60° (see FIG. 2). At the predetermined portion, the recording beam S, which is a p-polarized light, and the reference beam $, which is also a p-polarized light, interfere with each other, whereby a hologram is recorded optically efficiently. In the reproduction process, the reference beam R is directed to the predetermined portion while changing the incident angle in a manner similar to that in the recording process, and the reproduced light emitted from the predetermined portion is received by e.g. a photodetector. Thus, the information recorded as a hologram is reproduced.

The optical operation of the hologram recording device A1 will be described below.

For instance, in recording, the laser output (amount of light) from the light source 1 is 2.4, as shown in FIG. 2. By the PBS 3, the laser output is split into a recording beam S and a reference beam R in the light amount ratio of 1:1.4. The recording beam S impinges on the hologram recording medium B at an incident angle of 45°, and the irradiation area of the recording beam S at a predetermined portion is 1.

In this instance, since the illuminance is represented by the amount of light per unit area, the illuminance of the recording beam S at the predetermined portion is 1.

By appropriately controlling the movable mirror 9, the reference beam R is caused to impinge on the hologram recording medium B at incident angles of e.g. 30°, 45° and 60°. The irradiation area of the reference beam R at the predetermined portion is 1 when the incident angle is 45°.

When the incident angle of the reference beam R is to be 30°, the rotational posture of the dark filter 8 is controlled correspondingly. By the operation of the dark filter, the amount of the reference beam R, which has been 1.4 before passing through the dark filter 8, is reduced to 0.8. In this case, according to the cosine law of illumination, the irradiation area of the reference beam R at the predetermined portion is about 0.8. Thus, the illuminance of the recording beam S at the predetermined portion is 1. Thus, the recording beam S and the reference beam R interfere with each other, with the ratio of illuminance kept 1:1. As a result, a hologram having a good light/dark contrast is recorded at the predetermined portion.

When the incident angle of the reference beam R is to be 45°, the rotational posture of the dark filter 8 is controlled correspondingly. By the operation of the dark filter, the amount of the reference beam R, which has been 1.4 before passing through the dark filter 8, is reduced to 1. In this case, the irradiation area or lit area of the reference beam R at the predetermined portion is 1. Thus, also when the incident angle of the reference beam R is 45°, the illuminance of the recording beam S at the predetermined portion is 1. Thus, the recording beam S and the reference beam R interfere with each other, with the ratio of illuminance kept 1:1. As a result, a hologram having a good light/dark contrast is recorded at the predetermined portion.

When the incident angle of the reference beam R is to be 60°, the rotational posture of the dark filter 8 is controlled correspondingly. In this case, the amount of the reference beam R, which has been 1.4 before passing through the dark filter 8, is hardly reduced and reaches the predetermined portion almost as it is. According to the cosine law of illumination, the irradiation area of the reference beam R at the predetermined portion is about 1.4. Thus, also when the incident angle of the reference beam R is 60°, the illuminance of the recording beam S at the predetermined portion is 1. Thus, the recording beam S and the reference beam R interfere with each other, with the ratio of illuminance kept 1:1. As a result, a hologram having a good light/dark contrast is recorded at the predetermined portion.

In this way, in performing multiplex recording while changing the incident angle of the reference beam R, the illuminance itself of each of the recording beam and the reference beam is kept constant as well as the illuminance ratio of the recording beam S and the reference beam R.

Thus, according to the hologram recording device A1 of this embodiment, the constant illuminance ratio of the recording beam S and the reference beam R ensures the recording of a hologram having a good contrast. Moreover, since the illuminance itself of each of the recording beam S and the reference beam R is kept constant, the power for recording a hologram is constant regardless of a change in incident angle of the reference beam R. This ensures multiplex hologram recording with a constant optical power.

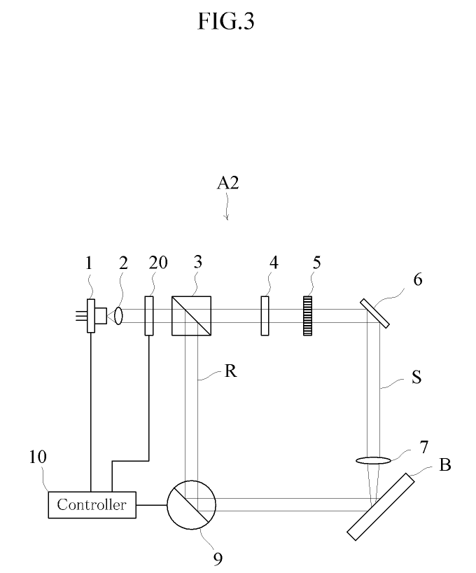

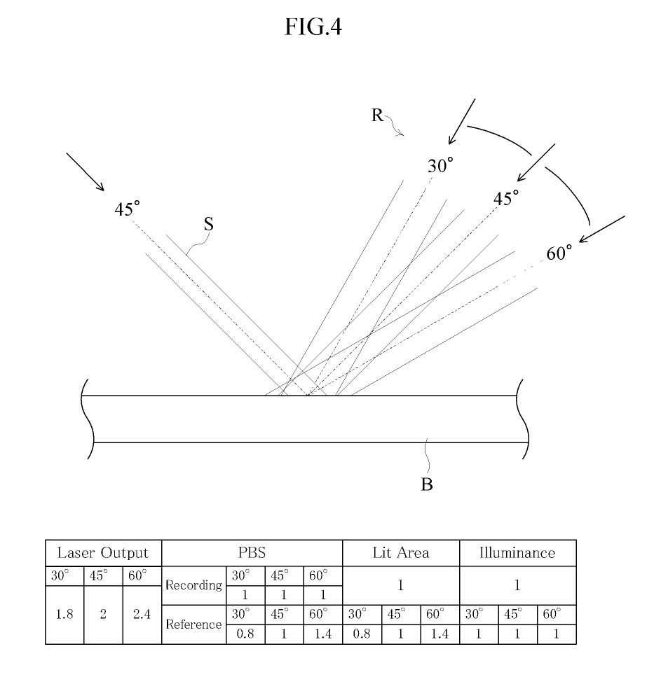

FIGS. 3 and 4 show a hologram recording device according to a second embodiment of the present invention. In the embodiments described below, the elements which are identical or similar to those of the foregoing embodiment are designated by the same reference signs as those used for the foregoing embodiment, and the description will be omitted.

As shown in FIG. 3, the hologram recording device A2 of the second embodiment includes a light source 1, a collimating lens 2, a phase adjustor 20, a PBS 3, a ½ wave plate 4, a spatial light modulator 5, a stationary mirror 6, an objective lens 7, a movable mirror 9 for reference beam, and a controller 10. The light source 1, the movable mirror 9 and the phase adjustor 20 are controlled by the controller 10. The controller 10 and the phase adjustor 20 constitute a light adjustor for variably adjusting the light amount and phase of the laser beam in accordance with the incident angle of the reference beam R.

The laser output from the light source 1 is adjusted by the controller 10 in accordance with the incident angle of the reference beam R. The laser beam exiting the collimating lens 2 enters the PBS 3 through the phase adjustor 20. The phase adjustor 20 comprises e.g. a ½ wave plate or phase modulating liquid crystal device which is arranged rotatably. The phase adjustor 20 changes the polarization direction of the laser beam by changing its rotational posture. The controller 10 controls the rotational posture of the phase adjustor 20 in accordance with the incident angle of the reference beam R. By changing the polarization direction of the laser beam before entering the PBS 3 by the phase adjustor 20, the ratio of light amount at which the laser beam is split into a recording beam S and a reference beam R in the PBS 3 is changed. After the splitting by the PBS 3, the reference beam R is directed to a predetermined portion of a hologram recording medium B via the movable mirror 9 to overlap the recording beam S.

For instance, in recording, the laser output (amount of light) from the light source 1 is changed in the range of 1.8 to 2.4, as shown in FIG. 4. Specifically, for instance, the laser outputs from the light source 1 are set to 1.8, 2 and 2.4 when the incident angles of the reference beam R are to be 30°, 45° and 60°, respectively.

After the laser beam is emitted from the light source 1, the phase adjustor 20 changes the polarization direction of the laser beam in accordance with the incident angle of the reference beam R. As a result, the ratio of light amount at which the laser beam is split into a recording beam S and a reference beam R in the PBS 3 changes. For instance, when the incident angles of the reference beam R are to be 30°, 45° and 60°, the laser beam is split at the PBS 3 into a recording beam S and a reference beam R in the light amount ratio of 1:0.8, 1:1 and 1:1.4, respectively. With this arrangement, the amount of the recording beam S coming out of the PBS 3 is constant even when the incident angle of the reference beam R changes.

The recording beam S is caused to impinge on the hologram recording medium B at an incident angle of 45°, and the irradiation area of the recording beam S at a predetermined portion is 1. Thus, the illuminance of the recording beam S at the predetermined portion is 1.

The reference beam R is caused to impinge on the hologram recording medium B at incident angles of 30°, 45° and 60°, and the irradiation area of the reference beam R at the predetermined portion is 1 when the incident angle is 45°. Similarly to the above-described first embodiment, the irradiation area of the reference beam R is about 0.8 when the incident angle of the reference beam R is 30°, whereas the irradiation area of the reference beam R is about 1.4 when the incident angle of the reference beam R is 60°.

Thus, the illuminance of each of the recording beam S and the reference beam R at the predetermined portion is 1 even when the incident angle of the reference beam R is changed. Thus, the recording beam S and the reference beam R interfere with each other, with the ratio of illuminance kept 1:1. As a result, a hologram having a good light/dark contrast is recorded at the predetermined portion. Further, when the incident angle of the reference beam R is changed, the illuminance itself of each of the recording beam S and the reference beam R is kept constant as well as the illuminance ratio of the recording beam S and the reference beam R.

Thus, the hologram recording device A2 of this embodiment also ensures multiplex hologram recording with a constant optical power as well as a good contrast.

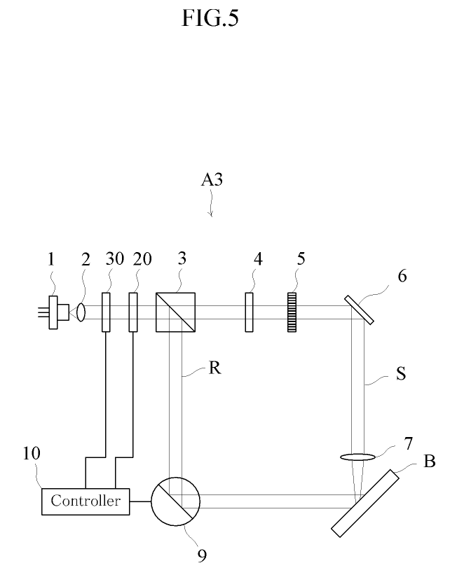

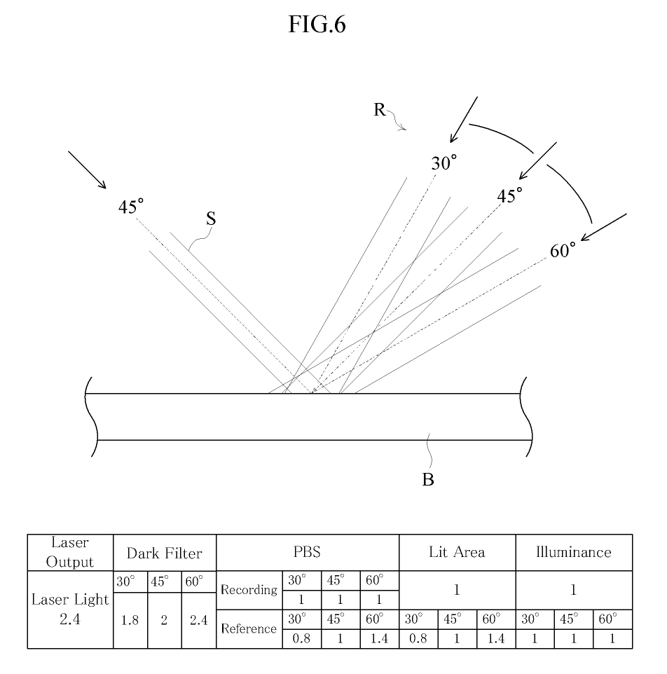

FIGS. 5 and 6 show a hologram recording device according to a third embodiment of the present invention.

As shown in FIG. 5, the hologram recording device A3 of the third embodiment includes a light source 1, a collimating lens 2, a phase adjustor 20, a light amount adjustor 30, a PBS 3, a ½ wave plate 4, a spatial light modulator 5, a stationary mirror 6, an objective lens 7, a movable mirror 9 for reference beam, and a controller 10. The movable mirror 9, the phase adjustor 20 and the light amount adjustor 30 are controlled by the controller 10. The controller 10, the phase adjustor 20 and the light amount adjustor 30 constitute a light adjustor for adjusting the light amount and phase of the laser beam in accordance with the incident angle of the reference beam R.

The laser output from the light source 1 is kept constant, and the laser beam from the light source 1 enters the collimating lens 2. After exiting the collimating lens 2, the laser beam enters the phase adjustor 20 through the light amount adjustor 30. For instance, the light amount adjustor 30 comprises a dark filter provided by the combination of an ND filter or a liquid crystal device and a polarizer. The controller 10 controls the rotational posture of the light amount adjustor 30 in accordance with the incident angle of the reference beam R. The light amount adjustor 30 appropriately reduces the laser beam by an amount corresponding to its rotational posture. The phase adjustor 20 has the same optical effects as those of the second embodiment.

For instance, in recording, the laser output from the light source 1 is kept 2.4, as shown in FIG. 6. When the incident angles of the reference beam R are to be 30°, 45° and 60°, the rotational posture of the light amount adjustor 30 is changed correspondingly so that the amount of the laser beam coming out of the light amount adjustor 30 become 1.8, 2 and 2.4, respectively.

After exiting the light amount adjustor 30, the laser beam travels in a manner similar to the second embodiment, and the phase adjustor 20 changes the polarization direction in accordance with the incident angle of the reference beam R. Thus, when the incident angles of the reference beam R are to be 30°, 45° and 60°, the laser beam is split at the PBS 3 into a recording beam S and a reference beam R in the light amount ratio of 1:0.8, 1:1 and 1:1.4, respectively. With this arrangement, the amount of the recording beam S coming out of the PBS 3 is constant even when the incident angle of the reference beam R changes.

The recording beam S is caused to impinge on the hologram recording medium B at an incident angle of 45°, and the irradiation area of the recording beam S at a predetermined portion is 1. Thus, the illuminance of the recording beam S at the predetermined portion is 1. The reference beam R is caused to impinge on the hologram recording medium B at incident angles of 30°, 45° and 60°, and the irradiation area of the reference beam R at the predetermined portion is 1 when the incident angle is 45°. Similarly to the above-described second embodiment, the irradiation area of the reference beam R is about 0.8 when the incident angle of the reference beam R is 30°, whereas the irradiation area of the reference beam R is about 1.4 when the incident angle of the reference beam R is 60°.

Thus, the illuminance of each of the recording beam S and the reference beam R at the predetermined portion is 1 even when the incident angle of the reference beam R is changed. Thus, the recording beam S and the reference beam R interfere with each other, with the ratio of illuminance kept 1:1. As a result, a hologram having a good light/dark contrast is recorded at the predetermined portion. Further, when the incident angle of the reference beam R is changed, the illuminance itself of each of the recording beam and the reference beam is kept constant as well as the illuminance ratio of the recording beam S and the reference beam R.

Thus, the hologram recording device A3 of this embodiment also ensures multiplex hologram recording with a constant optical power as well as a good contrast.

The present invention is not limited to the foregoing embodiments.

The numerical values given in the foregoing embodiments are merely examples and can be varied appropriately depending on the specifications.

As a variation of the first embodiment, the polarization beam splitter may be replaced with a half mirror for simply splitting laser beam into a same light amount ratio. In this case, it is not necessary to provide a ½ wave plate on the light incident side of a spatial light modulator, so that the number of parts reduces.

1. A hologram recording device comprising: a light source for emitting a laser beam; a beam splitter for splitting the laser beam from the light source into a recording beam and a reference beam; a spatial light modulator for modulating the recording beam in accordance with information to be recorded; a recording optical system for causing the modulated recording beam to impinge on a predetermined portion of a hologram recording medium; and a reference optical system for causing the reference beam to impinge on the hologram recording medium while changing an incident angle of the reference beam with respect to the recording medium so that the reference beam interferes with the recording beam at the predetermined portion at various angles, thereby enabling multiplex hologram recording on the predetermined portion by the interference between the recording beam and the reference beam;
wherein the hologram recording device further comprises a light amount adjustor for variably adjusting an amount of the reference beam exiting the beam splitter in accordance with the incident angle with respect to the hologram recording medium, so that illuminance of the reference beam at the predetermined portion is kept at a predetermined level.

2. The hologram recording device according to claim 1, wherein the beam splitter is a polarization beam splitter, the hologram recording device further comprising a phase plate for applying a predetermined phase shift to the recording beam between the polarization beam splitter and the spatial light modulator.

3. A hologram recording device comprising: a light source for emitting a laser beam; a polarization beam splitter for splitting the laser beam from the light source into a recording beam and a reference beam; a spatial light modulator for modulating the recording beam in accordance with information to be recorded; a phase plate for applying a predetermined phase shift to the recording beam between the polarization beam splitter and the spatial light modulator; a recording optical system for causing the modulated recording beam to impinge on a predetermined portion of a hologram recording medium; and a reference optical system for causing the reference beam to impinge on the hologram recording medium while changing an incident angle of the reference beam with respect to the recording medium, so that the reference beam interferes with the recording beam at the predetermined portion at various angles, thereby enabling multiplex hologram recording on the predetermined portion by the interference between the recording beam and the reference beam;
wherein the hologram recording device further comprises a light adjustor for variably adjusting an amount and a phase of the laser beam before entering the polarization beam splitter in accordance with the incident angle with respect to the hologram recording medium, so that illuminance of each of the recording beam and the reference beam at the predetermined portion is kept at a predetermined level.

4. The hologram recording device according to claim 3, wherein the light adjustor comprises: an output controller for controlling a laser beam output from the light source; and a phase adjustor for applying various phase shifts to the laser beam.

5. The hologram recording device according to claim 3, wherein the light adjustor comprises: a light amount adjustor for variably adjusting the amount of the laser beam; and a phase adjustor for applying various phase shifts to the laser beam.
